(19) United States
(12) Patent Application Publication
(10) Pub. No.: US 2009/0075847 A1
(43) Pub. Date: Mar. 19, 2009

(54) DRILLING FLUID LUBRICANT AND METHOD OF USE

(76) Inventors: Frank A. Wawrzos, McHenry, IL (US); Donald J. Weintritt, Lafayette, LA (US)

Correspondence Address: COOK ALEX LTD, SUITE 2850, 200 WEST ADAMS STREET, CHICAGO, IL, 60606, US

(21) Appl. No.: 11/957,634

(22) Filed: Dec. 17, 2007

Related U.S. Application Data
(60) Provisional application No. 60/972,375, filed on Sep. 14, 2007.

(51) Int. Cl. C09K 8/60

(52) U.S. Cl. 507/200

(57) ABSTRACT

A method for increasing drilling rates by reducing torque and drag in hostile environments such as high pressure, high temperature, and horizontal wells is provided by adding chemically and thermally inert spherical carbon beads to the drilling fluid.

### CROSS-REFERENCE TO RELATED APPLICATION

This application claims the benefit of the filing date of U.S. Provisional Application Ser. No. 60/972,375 filed on Sep. 14, 2007, and which is incorporated by reference herein.

### BACKGROUND OF THE INVENTION

The present application relates to the use of spherical carbonaceous particles for increasing the lubricity of a well drilling fluid during well bore drilling, and is particularly suited for use in environments where high pressure and high temperature pose significant challenges, such as directional drilling.

Drilling bores for oil and gas wells by the use of rotary drilling involves cutting through various types of subterranean formations, such as sandy shale and sandstone, which are extremely abrasive. Most oil and gas reservoirs are much larger in their horizontal plane rather than the vertical plane. Thus, a directionally drilled well significantly increases production and efficiency of the process. However, horizontal or directional drilling extraction methodologies further complicate well bore drilling.

Initially, a directionally-drilled well bore is drilled using the same rotary techniques that are used for vertical wells where the drill string is rotated at the surface. The drill string consists of steel joints of alloy pipe, with a collar providing downward pressure into the borehole. The drill bit is forced downward to cut through various rock and shale formations. As the drilling process continues, an arc is eventually formed to reach an oil or gas reserve. A number of methods for steering the drill bit to achieve this arc have been developed over the years, such as flexible coiled tubing, fluid-driven axial hydraulic motors, and downhole mounted motors. Downhole instruments near the bit transmit the sensor readings to the operators at the surface to aid the operators in steering the drill string toward the reservoir.

During the drilling process, metal moves against rock resulting in friction and heat. An excessive build-up of torque and/or heat can result in a stuck pipe situation, where a portion of the drillstring cannot be rotated or moved, causing significant well damage and down time. Lubrication and cooling can extend the life of drill bits and are particularly important in horizontal drilling, where the friction between the drill pipe, drill bit and rock surfaces must be kept to a minimum.

Drilling fluid, also called drilling mud, plays a critical role in rotary drilling for oil and gas exploration and production. Drilling fluids are formulated to provide suspension, pressure control, stabilization of formations, buoyancy, as well as lubrication and cooling, during well bore drilling. Drilling fluid is pumped from mud pits through the drill string, where it sprays out of nozzles onto the drill bit, cleaning, lubricating, and cooling the bit in the process. The fluid carries the cuttings up the annular space between the drill string and the well bore casing until it reaches the surface. The cuttings are then removed using shale shakers, and the drilling fluid is returned to the mud pit for reuse.

Drilling fluids may be formulated as water-based, synthetic-based, or non-aqueous, the latter being more commonly known as “oil based.” A generic water-based drilling fluid (known as EPA Generic Mud No. 7) comprises fresh water (1 lb/bbl), betonite (20 lb/bbl), lignosulfonate (20 lb/bbl), Drispac® cellulonic polymer (1 lb/bbl), caustic soda (1 lb/bbl) and barium sulfate (12 lb/bbl).

In many hostile environments, additives are used to supplement the drilling fluid to provide additional properties, such as loss circulation control or additional lubricity. Common additives include advanced synthetic polymers, glass or ceramic beads, and graphite particulates. Such graphite particulates may be in the form of naturally occurring, amorphous, or synthetic graphite. See, e.g., U.S. Pat. No. 5,826,669 which describes a method of preventing or controlling the loss of well drilling fluid into the pores and fractures of subterranean rock formations while providing lubrication properties by the addition of resilient graphitic carbon particles to the drilling fluid. These resilient graphitic particles are typically irregular in shape and contain jagged edges.

### SUMMARY OF THE INVENTION

The present invention involves the addition of spherical carbon beads to a drilling fluid to enhance its lubricity. The carbon beads preferably comprise fluid coke or shot coke particles. The fluid or shot coke may be green, but is preferably calcined, and comprises beads having a particle size range of from −10 mesh to +325 mesh, as determined by screen/sieve sizing. Preferably, the coke beads have a particle size range of from −20 mesh to +200, and even more preferably (with 50% to 80% of the particles (by mass) having a particle size range of from −60 mesh to +100 mesh In another aspect of the invention, the coke particles have a true density, as measured by using a pycnometer, of from about 1.45 g/cc to about 2.2 g/cc and a coefficient of friction of from between about 0.16 The coke particles are added to a drilling fluid in concentrations of from between about 15 lbs/bbl to about 125 lbs/bbl.

### BRIEF DESCRIPTION OF THE FIGURES IN THE DRAWINGS

FIG. 1 is a graph of resiliency (in percent) vs. compression cycles for purified-graphitized fluid coke (7001) and a coke additive of the present invention (7016) at compression forces of 10,000 psi, 5,000 psi and 3,500 psi.

FIG. 2 is a bar graph comparing the coefficients of friction for purified-graphitized fluid coke (7001), a coke additive of the present invention (7016) as lubricants for a steel on steel interface.

FIG. 3 is a scanning electron microscope (“SEM”) micrograph of calcined fluid coke according to one aspect of the present invention.

FIG. 4 is a schematic diagram of a cross section of a Lubricity Evaluation Monitor (“LEM”) test cell used in generating the data presented in Table 3.

### DETAILED DESCRIPTION

The present invention is directed to the addition of spherical carbon beads, preferably in the form of shot coke or fluid coke, to a well drilling fluid to improve its lubricity. Methods for obtaining shot coke and fluid coke are known in the art. Fluid coke is the byproduct of a pyrolytic upgrading of heavy hydrocarbons, which use fluidized bed techniques. Shot coke is produced as a by-product of delayed coking.

Fluid coking is a continuous process in which heated coker feeds are sprayed into a fluidized bed of hot coke particles, which are maintained at 20-40 psi and 500° C. The feed vapors are cracked while forming a liquid film on the coke particles. The particles grow by layers until they are removed and new seed coke particles are added. Hydrocarbon feeds are introduced into the fluidized bed at given levels through nozzles and are pyrolytically decomposed in the reaction zone forming hydrocarbon vapors which are withdrawn for further processing. Consequently, a portion of the solids is removed from the reaction zone to recover the net product coke. The coke is then returned to the reactor so as to maintain an appropriate constant particle size distribution in the reactor and in part to circulate some of the coke to a heater where the circulating coke is heated and then returned to the coking reactor to supply the required heating. Excess coke falls to the bottom of the reactor and is steam stripped as it exits the reactor bottom to remove absorbed hydrocarbons. After recycling of the coke, fresh hydrocarbon feed is introduced for processing. The byproduct of the reaction is spherical fluid coke suitable as a fuel source, or in the case of this method, a lubricant. The final fluid coke consists of spherical particles with a smooth non-porous surface and an “onion-like” internal structure.

Delayed coking is a thermal cracking process used in petroleum refineries to upgrade and convert petroleum residuum into liquid and gas product streams leaving behind a petroleum coke. A fire heater with horizontal tubes is used in the process to reach thermal cracking temperatures of 485-505° C. Because of the short residence time in the furnace tubes, coking the feed material is “delayed” until it reaches large coking drums downstream on the heater.

The production of shot coke in a delayed coker requires high concentrations of asphaltenes in the feedstock and high coke drum temperatures. A coker feedstock high in oxygen content can also produce shot coke.

The present trend in refineries is to run heavier crudes with higher asphaltene contents and to improve operation of the vacuum distillation unit to produce a heavier vacuum reduced crude with higher asphaltene content.

Shot coke is produced as the oil flows into the coke drum. With the light ends flashing off, small globules of heavy tar are suspended in the flow. These tar balls rapidly coke due to the exothermic heat produced by asphaltene polymerization. The balls then fall back into the drum as discrete little spheres two to five millimeters in size. In the main channel up through the drum, some of the spheres will roll around and stick together forming large balls as large as 25 centimeters. When these large balls are broken, they are found to be composed of many of the two to five millimeter size balls. Shot coke is unique in that the small spheres two to five millimeters in diameter, each have a slick shiny exterior coating of needle or acicular type carbon. The inside of each sphere contains isotropic or amorphous type coke.

The coke, whether fluid or shot, may remain in its current state as green coke, or it can be calcined. During calcination, the coke is passed through a revolving kiln comprising refractory lined cylinders. As coke moves through the revolving kiln, it is progressively heated to about 1200-1400° C. Water and volatiles are driven off and the remaining carbon-rich solids are partially graphitized. The calcined coke is cooled with water. While calcined coke may be high thermally treated (i.e., to temperatures in excess of 1800° C.) to increase its level of graphitization, such thermal treatment is not required with respect to the spherical carbonaceous materials of the present invention, as they achieve a similar level of lubricity relying on its particular morphology, density, and particle size.

Preferred fluid coke particles for use in this invention are commercially available from Superior Graphite Co., Chicago, Ill. as product number 7016. Typical composition of the preferred material is shown in Table 1:

TABLE 1

| Sample No. | Fluid coke (7016) |
|---|---|
| Trial No. | 5-17-07 |
| LOI (%) | 99.61/99.59 |
| Ash (%) | 0.39/0.41 |
| Volatiles (%) | 0.15 |
| Moisture (%) | <0.10 |
| Sulfur (%) | 2.24/2.49 |
| True Density (g/cc) | 1.96 |
| Resistivity (ohm in.) | 0.0461 |
| Resiliency (%) | 21 |

In some applications the preferred particle size distribution is 100% passing through a 200-mesh screen (i.e., −200 mesh) so that the lubricating material will pass through the shaker screens used in filtering the cuttings from the drilling mud. The preferred particle size distribution is 90% or more of the particles passing through a 20 mesh screen and being retained on a 200 mesh screen (i.e., −20 mesh to +200 mesh). Ideally, between 50% and 80% of the particles are between 60 mesh and 100 mesh in size (−60 mesh to +100 mesh). Such a particle size distribution is shown in Table 2:

TABLE 2

| Mesh | Mm | Fluid coke |
|---|---|---|
| 16 | 1.19 | |
| 20 | 0.850 | 0.00% |
| 30 | 0.600 | Trc. |
| 40 | 0.425 | Trc. |
| 50 | 0.300 | 3.70% |
| 60 | 0.250 | 9.70% |
| 70 | 0.212 | 30.80% |
| 80 | 0.180 | 29.40% |
| 100 | 0.150 | 17.50% |
| 200 | 0.075 | 8.90% |
| PAN | n/a | Trc. |

The resiliency of the spherical carbon particulates affects the compressive strength performance and onion layer separation needed during friction reduction. The resiliency of the materials is preferably in the range of 5% to 50%, and more preferably averages 20%.

To determine resiliency, as used herein, the following procedure is used. First, a compression test cylinder is filled with 16 grams of dried, finely divided material to be tested. The material is compressed in a hydraulic press until the gauge needle reads zero. The height of the material in the cylinder is measured and recorded. The material in the cylinder is then compressed to 10,000 psi, and the height is measured again. The pressure is released and the cylinder is removed from the press and allowed to stand until no more expansion of the material is observed. The height of the material in the cylinder is again measured, and this height minus the height at 10,000 psi is divided by the height at 10,000 is psi and multiplied by 100 to obtain the percent expansion.

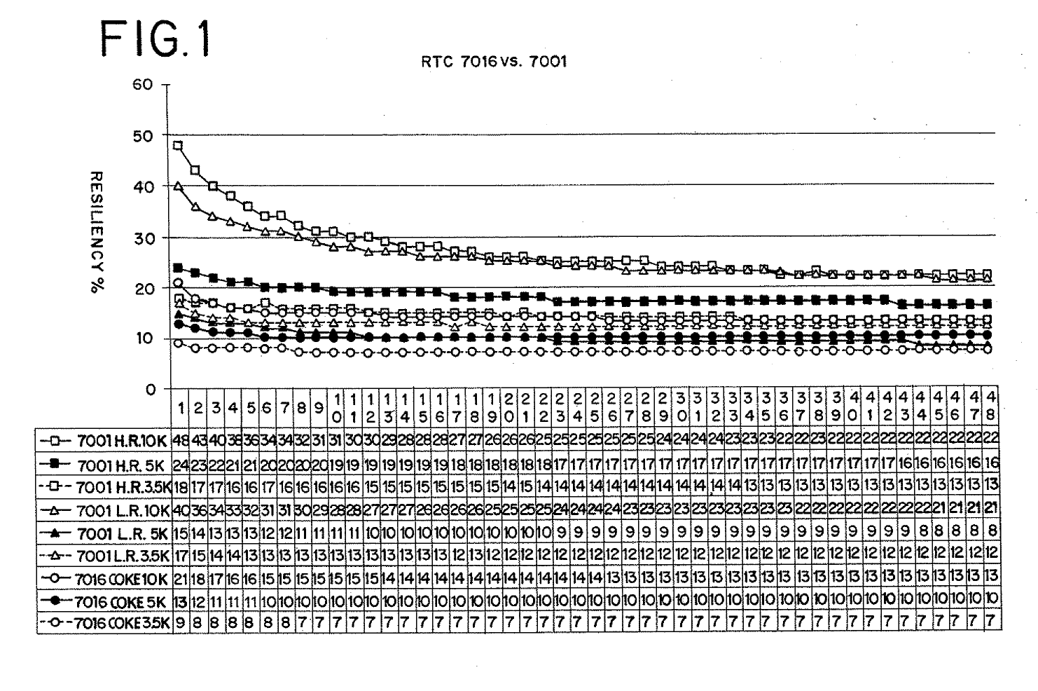

The compressive strength of resilient materials is determined in a similar fashion, with resiliency measurements being taken at 10,000 psi, 5,000 psi, and 3,500 psi while being cycled to acquire a minimum of 20 data points. The compressive strength of the spherical carbonaceous materials of the present invention allows resiliency to remain consistent over multiple pressure ranges and cyclic compressions, as seen in FIG. 1, which provides a comparison of calcined fluid coke (7016) with thermally purified-graphitized fluid coke known as GlideGraph (7001) (both available from Superior Graphite Co., Chicago, Ill.).

The density of the spherical carbonaceous materials is also an aspect of the present invention. Preferably, the materials have a true density, as measured with a pycnometer, of from about 1.45 g/cc to about 2.2 g/cc. This helps to ensure that the particles remain suspended in the drilling fluid to which they are added.

Lubricity (as indicated by the coefficient of friction) of the spherical carbonaceous materials, particularly calcined fluid coke, was also measured to determine its performance versus graphitized fluid coke. Graphitized fluid coke (such as GlideGraph 7001 and 9400, supplied by Superior Graphite Co., Chicago, Ill.) has been used as a friction reducer in the oil field market since 1998. Graphitic particulates provide high levels of lubrication, regardless of shape and morphology due to the high level graphitization, which is in the 80-95% range. It is an aspect of the present invention that the use of properly sized spherical coke materials can provide similar performance without being graphitized.

The coefficient of friction is an empirically-determined value that is associated with the force required to move one object pressed against object another relative to a normal force with which the two objects are being pressed together. The force required for motion is linearly proportional to the normal force, and the ratio between the two is the coefficient of friction (always between 0 and 1). Friction comes from the interaction between the two surfaces at the level of the atoms and molecules, and can often be significantly reduced by interposing a lubricant between the two surfaces.

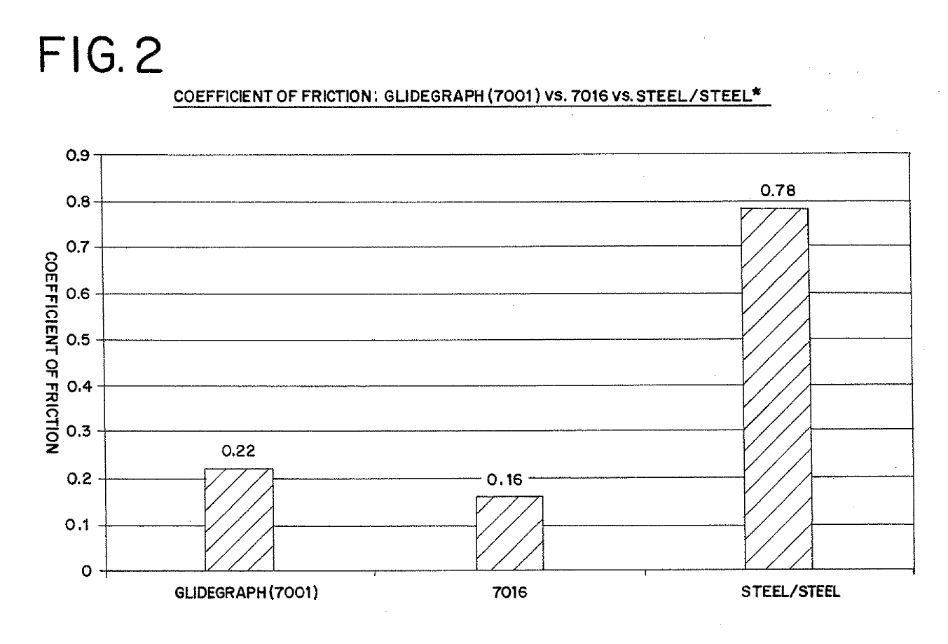

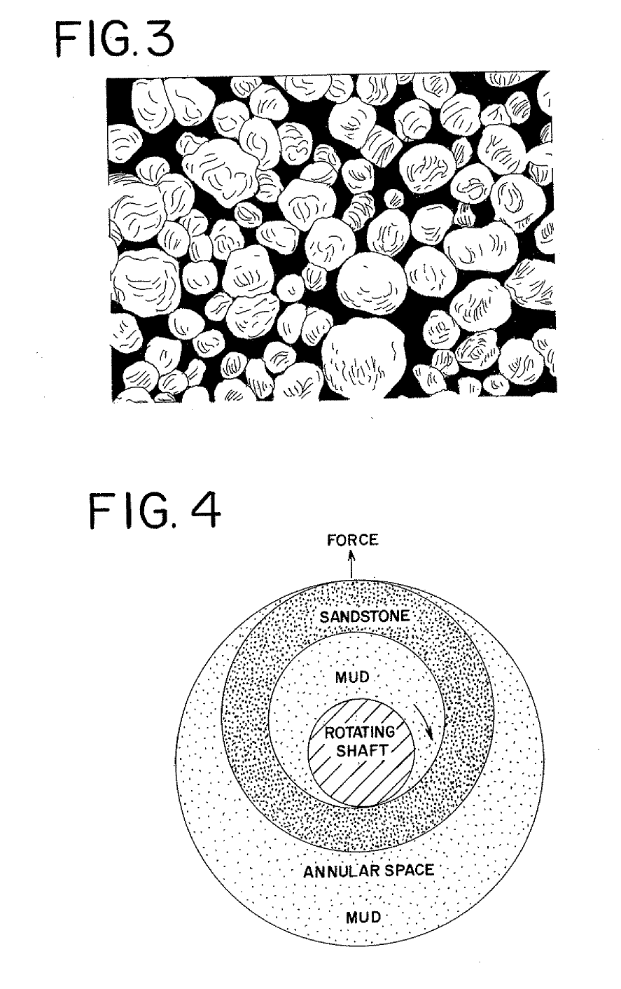

Samples of graphitized fluid coke (7001) vs. non-graphitized fluid coke (7016) were evaluated using a Falex Multi Specimen Tester with Load Lever using a powder friction adapter. The Falex tester allows the coefficient of friction between a steel on steel interface to be determined by adjusting the rotational speed, load, and temperature of the sample. Testing parameters for the results set forth in FIG. 2 included a rotational speed of 60 rpms, test load number four, and ambient temperature. The results indicate that the non-graphitized fluid coke (7016) should reduce friction as well as, if not better than, the graphitized fluid coke (GlideGraph 7001), as the coefficient of friction for the non-graphitized fluid coke is less than that for the graphitized fluid coke (0.16 vs. 0.22), as contrasted with the coefficient of friction between the steel over steel interface in the absence of any lubricant (0.28). Scanning electron microscope photograph of the calcined (but not graphitized) fluid coke comprises FIG. 3.

Additionally, drilling fluid additives may be evaluated using a Lubricity Evaluation Monitor (LEM). The LEM accurately simulates frictional forces encountered in drilling under a variety of downhole conditions). For the purposes of this invention, the LEM was used to simulate the frictional force of metal to mineral (i.e., the drill string against borehole wall). Drilling conditions are simulated by rotating a stainless steel shaft, representing the drill string, against a formation surface such as Bandera Sandstone, representing the borehole wall. To simulate torque and drag, a load is applied tangentially to the inner annular surface. A simplified sketch of the shaft sliding against a sandstone core is shown in FIG. 4. This generates a torque moment through the shaft, indicative of the friction condition of the surface contact or, conversely, of the lubricating ability of the drilling fluid. About 500-ml of drilling fluid fills the stainless steel cell sample holder. The lubricant additives were tested in a EPA Generic Mud No. 7 mud system, which was described above. A comparison of calcined fluid coke 7016 with graphitized fluid coke 7001 and Ven-Lube 1 (a commercial liquid lubricant) in an EPA approved generic mud appears in Table 3. No load base calibration value was constant for all runs.

TABLE 3

| Run. | | | | % Torque Reduction | | | | |
|---|---|---|---|---|---|---|---|---|
| No. | Base fluid | Additive | Conc. | Initial | 5-min. | 10-min. | 15-min. | 20 min |
| 1 | Water | — | — | — | — | — | — | — |
| 2 | Mud | — | — | — | — | — | — | — |
| 3 | Mud | VenLube I | 2 (vol) % | 0 | 15 | | | |
| 4. | Mud | 7001 | 20 lb/bbl | 60 | 15 | 25 | | |
| 5. | Mud | SG-7016 | 20 lb/bbl | 60 | 66 | 45 | 25 | 25 |

As shown in Table 3, the method of the present invention results in a significant torque reduction over a longer time period than the previously known additives.

Field Trial

A field trial was conducted in order to assess the efficacy of the spherical calcined fluid coke under actual conditions. The trial took place on a land rig in Trinity, Tex. that was attempting to drill a well horizontally. The high temperature/high pressure well was drilled with a water based drilling fluid. The rig operators experienced adverse drilling conditions, which reduced drill rates and could potentially cause a stuck pipe situation. It is anticipated that the spherical carbonaceous particles of the present invention can be added to drilling fluid in concentrations of from between 15 lbs/bbl to about 125 lbs/bbl. In the present field trial, 7016 fluid coke was added to the drilling fluid in 20 lb/bbl sweeps at a concentration of 10 lbs/bbl in order to increase lubricity and reduce the likelihood of unfavorable effects due to the harsh conditions. After the addition of 7016 fluid coke, operators noted a reduction of 15-20% in torque at the critical stage of the drilling process. A total of 7,500 lbs of material was used during this trial.

Thus, a method for enhancing the lubricity of a well bore drilling fluid has been provided. While the method has been described by reference to certain preferred embodiments, there is no intention to limit the invention to the same. Instead, it is intended that the following claims define the scope of the invention.

1. A method of enhancing the lubricity of a well bore drilling fluid comprising adding spherical carbon beads with a particle size of −10 mesh to +325 mesh.

2. The method of claim 1, wherein said particles have a resiliency of greater than 5% rebound after compression at 10,000 psi.

3. The method of claim 2, wherein said resiliency is between 5 and 50%.

4. The method of claim 1, wherein said particles have a resiliency measured after 20 cycles of 10,000 psi compression of between about 5% and about 50%.

5. The method of claim 1, wherein such beads are made from green fluid coke.

6. The method of claim 1, wherein such beads are made from green shot coke.

7. The method of claim 1, wherein such beads are made from calcined fluid coke.

8. The method of claim 1, wherein such beads are made from calcined shot coke.

9. The method of claim 1, wherein such beads have a coefficient of friction between 0.16 and 0.22.

10. The method of claim 1, wherein the carbon bead density is about 1.45 to 2.2 g/cc.

11. The method of claim 1, wherein the drilling fluid is water based.

12. The method of claim 1, wherein the drilling fluid is oil based.

13. The method of claim 11, wherein the spherical carbon particles are added to the drilling fluid in concentrations between about 15 to 125 lbs/bbl.

14. The method of claim 12, wherein the spherical carbon particles are added to the drilling fluid in concentrations between about 15 to 125 lbs/bbl.

15. The method of claim 1 wherein the spherical carbon beads have a particle size of −20 mesh to +200 mesh.

16. The method of claim 15 wherein the spherical carbon beads are sized so that 50% to 80% of the particles, by mass, are from −60 mesh to +100 mesh.
